(19) United States
(12) Patent Application Publication
(10) Pub. No.: US 2013/0224330 A1
(43) Pub. Date: Aug. 29, 2013

(54) BODY WEIGHT GROWTH OF WEANING PIGS

(71) Applicant: LABORATORIO JAER, S.A., (US)

(72) Inventors: Manuel MILAN MESA, Barcelona (ES); Gabriel Marti Sanroma, Barcelona (ES); Sergio De Cozar García, Barcelona (ES)

(73) Assignee: LABORATORIO JAER, S.A., Barcelona (ES)

(21) Appl. No.: 13/785,230

(22) Filed: Mar. 5, 2013

Related U.S. Application Data
(63) Continuation-in-part of application No. 12/613,838, filed on Nov. 6, 2009, now abandoned.

(51) Int. Cl. A23K 1/16; A23K 1/18

(52) U.S. Cl. CPC A23K 1/1646; A23K 1/1893; A23K 1/1634
USPC 426/2

(57) ABSTRACT

A method of improving the body weight growth of weaning pigs is disclosed comprising the step of providing a concentration of xylitol in the range of between 0.01 and 4% by weight in the weaning pigs' food where food is any substance with a nutritional value, including water.

### CROSS REFERENCE TO RELATED APPLICATIONS

This application is a continuation-in-part of U.S. Ser. No. 12/613,838, filed on Nov. 6, 2009.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to the field of pig farming production. Specifically, it relates to the improvement in the body weight growth of weaning pigs.

### BACKGROUND OF THE INVENTION

In intensive pig farming the time taken to fatten up an animal is of vital importance, as the economic viability of the operation depends on it. Said timing being the least so that an animal reaches the sales weight depends on certain zootechnical factors amongst which the feed stands out. The feed is a central question in intensive production. It has been proven that the higher the intake of animal feed the higher are the transformation indexes of the food consumed into meat, and therefore the less time necessary to reach a suitable weight, hence the economic impact is double, on one hand the animals grow more with less feed and on the other hand, on reaching a suitable weight sooner, the occupation of the farm installations is less, both factors directly affecting the profitability of the process.

In regard to the peculiarities of the feeding, the rearing of pig farming can be divided into three phases that are easily distinguishable between each other from the differences in their characteristics: Lactation, weaning and feeding. The economic optimization of the animal breeding activity depends on the correct achievement of these three phases, that will produce healthy suckling animals and with a good weight, without deteriorating the weaning and, finally, with a faster feed period without lessening the health quality.

In the lactation phase of the animals the aim is to keep the lactating sows within the optimal zoo-technical parameters. In order to do this, the lactating sow must not stop drinking water and eating the feed that is necessary. The effect that the mid summer heat has on the lactating sows is well known in so far as the reduction of the appetite. The consequence of this is the failure to consume sufficient feed and/or water so as to maintain the production of milk, and as the suckling phase is a priority, the energy deficit is paid for with the loss of metabolic mass. The current pig breeds have been chosen by placing a high degree of importance on the criteria of prolificacy (number of piglets per pregnancy), hence the milk demand on the mother is higher and the problem is aggravated. The consequence of a reduction of the intake of feed once having exceeded a certain loss of weight, the sow delays the oestrus after the weaning and therefore, in spite of a good prolificacy, the number of annual pregnancies falls and with this the number of piglets, hence the productive indexes of the operation move away from that which is profitable.

The enzymatic system of the piglet is exclusively prepared to digest the nutrients contained in the sow's milk, the adaptation of the enzymatic system to a new diet is a dynamic process that takes time.

The weaning phase occurs when the animal is around three weeks old involves a harsh change from liquid feed to a solid diet, and a change from milk proteins and sugars to vegetables. This situation generates a period in which the animal is deficient in energy, and goes from growing fast to not growing and can even lose metabolic mass, up to the point of not ingesting the amount of feed necessary to satisfy its growth potential capacity. This critical phase of adaptation must be as short as possible and depends exclusively on the amount of feed ingested during these first hours. The longer the time that the adaptation to solid animal feed takes reduces the possibilities of optimum development. The deterioration suffered in this phase will be a permanently increased factor during the feeding of the animal.

During the feed phase, the greater the intake will mean greater performance of the pig rearing operation. But the current intensive pig farming is based on breeds of pigs that, even though over centuries have been the object of genetic selection, continue to have a limitation in their capacity to eat which is the main obstacle for the obtaining of all of their economic potential. Attempts have been made to overcome this obstacle, for example, by feeding the animal with concentrated diets, made up almost exclusively of cereals and pulses, and also by applying certain feeding strategies: Hours of availability of food and light, automatic feed dispensing, location of drinking troughs, etc. Also certain antibiotics have been used which, even though they do not have nutritional value, they affect the transformation of the feed into meat. All of these techniques together form the current attainable limit, but its satisfaction is not unanimous, for example some reduce the hours of sleep with the consequent tiredness of the animal, whilst others introduce medicines that are to be avoided.

Attempts have been made to solve the problems caused by the fall of the consumption in the reproducing sows and for the fall in the consumption in the weaning piglets, including in both cases the stress posed by the inclusion of new feeds for the animals. Some examples are quoted below.

Patent UA29235U deals with the problem of the reduction of the stress and the improvement of the productivity in the piglets, by means of the intramuscular administration of an inorganic chrome compound. U.S. Pat. No. 3,534,095 and U.S. Pat. No. 5,006,558 patents deal with solving the problem by administering magnesium salts. Patent JP2004135543 proposes the preparing of animal feed containing between 30% and 50% saccharides. Patent CN101223913 proposes an animal feed that improves the survival and growth of the piglets by means of the administration of liquid feed made from a lactose and plasma protein base and where some 50%-60% is fresh milk. Patent JP2001309752 proposes an animal feed for piglets with a palatability improvement that allows for an increase of the consumption and more rapid growth, made with products coming from an enzymatic egg hydrolysis. Patent JP3198750 describes a granulated feed for newly weaned piglets with a milk powder, cereal powder and rice vinegar base. Patent EP0457953 improves the feed palatability given to piglets by means of complex feed formation process, covered with sucrose, without the sucrose exceeding 6% in the final feed. Patent JP2004135543 proposes an animal feed made from 30%-50% dextrin, and with added saccharides which, in accordance with the patent, have a sweetness index of 20, in comparison to 100 for the pure sucrose. Patent JP2008253190 proposes an animal feed to encourage piglet growth which contains between 0.01% and 1% extract of Mormordica grosvenori. Patent CN1075852 proposes the addition of ground bone meal as an additive to increase the intake of food by the pigs, with all of the safety problems that this brings with it due to spongiform encephalopathy. Patent CN1072568 proposes an additive based on oligoelements, acetylsalicylic acid and furazolidone, which seems to increase the intake of feed somewhat. Patent EP0502931 proposes an animal feed free of chemical substances, hormones or antibiotics, but it must be accompanied by butter, skimmed milk and potatoes, which means a considerable cost increase for the feed.

All of the solutions quoted can provide a remedy to the problem of stress, palatability, or the improvement of the intake and/or growth of the piglets, but many of them have one or several disadvantages, such as substances must be administered with a pharmacological activity, or their administration is by intramuscular means, or that an extraordinary amount of sweetening substances must be added to the feed, or that complex processes have to be resorted to, or equally raw materials are used which considerably increases the cost of the final feed.

On the other hand, other solutions have been proposed for the economic improvement of intensive animal farming such as the following:

Patent CN1075852 proposes the addition of ground bone meal as an additive to increase the intake of food by the pigs, with all of the health problems that this brings with it due to the risk of spongiform encephalopathy. Patent U.S. Pat. No. 6,224,917 shows a method that uses calcium carbonate administered as a food supplement during the periods of strong animal growth so as to improve the bone metabolism; the calcium carbonate has to be accompanied by additives that specifically intervene in the bone metabolism of the calcium, specifically xylitol and ascorbic acid; one of the examples that it gives is with chicks and poultry which, as is well known, do not have a sense of taste, therefore, the effect of these additives does not have an effect on the intake of the food, but it does have an influence on the required incorporation of calcium into the skeleton. In patents ES 2201908 and EP 1462 101 it is proposed that the treatment of animals suffering from processes with fever, inflammation and pain be made by means of a galenic form that contains ketoprofen as main active agent prepared with diluting excipients such as poly-alcohols, from all of those stated as possible. In the documents ES P200802691, ES P200901651 and WO 2009000448, all belonging to the same owner as this present invention, the advantageous use of xylitol or its derivatives is revealed for the taste concealment of the chemical therapies of the quinolone-o-naftiridoncarboxólic acid group administered in feeds intended for pigs, feeds that in another way are clearly rejected, because of the strong bitter taste of said chemical therapies, bringing considerable weight loss in the animals with said rejection. Patent CN1072568 proposes an additive based on oligoelements, acetylsalicylic acid and furazolidone, which increases the intake of feed somewhat. Patent EP0502931 proposes an animal feed free of chemical substances, hormones or antibiotics, but it must be accompanied by butter, skimmed milk and potatoes, which means a cost increase for the feed.

Furthermore, some additives have been used to improve the adult development in pigs, but when the animals are projected to human consumption, such veterinary additives are subject to legal controls that typically grow more and more restrictive. Thus, the Antibiotic Growth Promoters (AGP), that were introduced in the 1950's as food additives on pigs to human consumption with spectacularly good results, were banned at the beginning of the 2000's because of secondary effects on human medicine.

The AGP banning brought a notable reduction in the pig growth economic efficiency and has forced the sector to find new additives to substitute the AGP's. Despite the important economic interests involved, no additive is yet in use with the universal properties of being functional to pigs while harmless to humans or to the environment.

The economic urge from the sector has led the research path to a wide number of substances suspected, because of human analogies and other reasons, to provide fast healthy weight growth in pigs. But none has yet turned out to be satisfactory, each of them showing some sanitary, or ecologic, or economic drawback and no one equaling the economic results obtained with AGP.

The additives which have hitherto been proposed to replace AGP belong to some of the following groups:

Acidifying agents to help the limited hydrochloric acid production in the piglet stomach. These agents show poor results.

Glucose or sorbitol. Their effect is very slight and not clear. Sucrose cannot be used as food additive because the industrial preparation of pig food goes through a high temperature process during which the sucrose caramelizes. The fact of not having found changes in the pig's feeding behavior against the familiar sugars, glucose or sorbitol may have led the researchers, in an exercise of an a fortiori logic, to the conclusion that it would be useless to spend more money trying with other sugars.

The therapeutic zinc oxide (ZnO), as it reduces the diarrheic incidences in weaning pigs. But ZnO is left intact back in the environment, where it exerts a harmful influence. Therefore its veterinary use is limited to very restrictive doses and conditions.

Enzymes. Their effect improving the growth rate in pigs is not clear. While carbohydrates and proteases have been used in poultry quite successfully, this has not been the case in pigs. A number of studies have shown that exogenous enzymes can improve the digestibility of nutrients in feedstuffs commonly used in pig diets, though the positive increases in digestibility are not consistently translated into improvements in growth performance, especially in diets based on corn and soybean meal.

Mineral clays. These are substances that have the ability to absorb toxins from the digestive systems which may allow pathogenic bacteria to proliferate. Attapulgite, smectite or kaolinite would be typical examples. Although it is proved that the inclusion of mineral clays in the diet of weaning pigs reduces the diarrhea, it doesn't have any effect in the growth rate.

Fermentation. Certain diets provide the opportunity to create acid conditions by fermentation through the inclusion of certain micro organisms such as lactobacillus species prior to feeding. The establishment of the latter in the intestine, particularly in the weaned pig, helps to prevent the establishment of pathogenic bacteria. Fermentation also increases the digestibility of the diet with increased efficiency of use. The results are not enough clear to implement this system in intensive farming.

Probiotics. These are living cultures of bacterium and bacillus species and yeasts. The exact way in which they would promote growth is unclear and its positive effect is not very clear.

Nutraceuticals. These are substances originating from different plants and, whilst many claims are made for their effectiveness, they are yet to be substantiated with confidence. Fatty acids and plants with high levels of vitamin E are claimed to increase the efficiency of the immune system. Claims are also made for garlic, ginseng, oregano and extract of cinnamon, aniseed, rosemary and peppermint, as well as for propolis extracted from honey. Their economic cost is high.

### SUMMARY OF THE INVENTION

The use of xylitol or its derivatives to maximise the daily voluntary intake of animal food in intensive pig farming, understanding that food includes any substance with a nutritional value, including water. In particular, the use of xylitol in weaning pigs' food to improve the rate of the body weight growth in the weaning pigs.

The use of from 0.01% to 4% of xylitol in weight with respect the feed provides surprising and unexpected results by improving the rate in body weight growth of weaning pigs. Surprisingly, the use of xylitol in food or water also reduces the time of permanence of the food in the stomach which helps the weaning pig to resume its eating and voracious activities.

Additional benefits of the use of xylitol, especially in comparison to the other attempted methods to provide fast healthy weight growth in pigs include:

Unlike the other attempted, but unsuccessful methods and compositions, pigs fed with the xylitol-containing food is harmless to humans; and

Unlike the other attempted, but unsuccessful methods and compositions, the use of xylitol-containing food is innocuous to the environment.

### DETAILED DESCRIPTION OF THE INVENTION

This present invention provides a considerable improvement in the intensive pig farming operation taking into account the peculiarities that the feeding of the pigs presents in the three phases of its rearing, hence establishing a single food that is applicable to both the lactating sows and equally for the weaned piglets, and also the adults in the feed. The use of a single protocol naturally means a saving of resources and reduces possible mistakes and the consequences of them.

This invention consists of the use of small amounts of xylitol both in the drinking water and equally in the feed chosen for each one of the three phases. No other additive known, be it sugar, vitamin, antibiotic, etc. in similar concentrations and validity in the three phases shows the effect for pigs that was unexpected and not obvious on the complete acceptance of the feed that the pigs showed when the present invention is applied.

Xylitol is a sugar of a natural origin and in accordance with the merits of the present invention mixed with the corresponding feed in a final concentration of between 0.01% and 4% by weight, solves the lack of appetite of the lactating sows even in climatic conditions that are known as adverse, reducing or eliminating the reproductive problems arising from it. Due to the palatability, it also brings about the immediate acceptance of solid food by the recently weaned piglets, with which the above described disadvantages disappear. Finally, also because of the palatability, the presence of xylitol in the feed feed makes the adults consume a great deal more. The overall result has a high impact on the economic results of all of the productive process. The addition of xylitol in the proposed concentrations means a clear improvement in all of the productive process phases of the intensive pig farming operation, without placing either the quality of the meat or the health of the animals at risk.

The mixture of xylitol in the feed of the pig species allows the lack of appetite to be solved for the lactating sows during the feeding period for the piglets, reducing or eliminating the reproductive problems arising from it. The problems arising from a low intake of food during the critical moments of the weaning of the piglets are reduced or eliminated, making the uptake of a solid diet easier. And during the fattening phases, it allows the consumption of feed to be maximised where the growth is greater and therefore the conversion of the feed into meat is higher.

The clear improvement of the palatability of the feed for the pigs also allows feed to be made on the basis of the nutritional values of the components, with less restrictions conditioned by the lower palatability of the components, making up more economic portions but with an equivalent nutritional value, for example it allows the rate of the addition of sorghum to be appreciably increased.

The use of xylitol can go together with any other compound of a synergic effect with it, boosting the palatability of the feed or the aqueous dissolution or reducing the proportion of xylitol to be added. Some examples of the synergising product are acesulfame, alitame, aspartame, superaspartame, dulcin, monellin, neohesperidine dihydrochalcone, 5-nitro-2-propoxianilline, saccharine, sucralose, thaumatine, amino-acids such as arginine, glycine and tryptophan, or other sugars other than xylitol or glucosides such as those coming from Glycyrrhiza glabra or from Estevia rebaudiana, likewise the salts or compounds from any of them.

Under the terms of this present invention the xylitol can be added on its own or forming a part of a more complex preparation accompanied by any auxiliary excipient such as solvents and substances that make the solubility easier, preservatives, anti-oxidants, light protectors, colorings, reabsorption booster products, disintegration boosting agents, agglutinants, lubricants and stabilisers, depending on the final form of the product. Such formulations can be both dissolutions and equally solid preparations, intended to be mixed with feed and equally with the drinking water.

Therefore, the products arising from this present invention are all of those that contain xylitol, be they as the main substance or as an excipient, and are directly or indirectly intended for pig feed, including the drinking water, and an increase in the palatability arises from its use, and hence from the consumption.

According to the invention, the use of xylitol leads to an increase of the consumption of the normal food. The use of xylitol surprisingly and unexpectedly improves the rate of the body weight growth, especially in weaning pigs.

The reason some have focused their attention on sugars as additives relies in the historically well-known fact that sugars increase the food palatability in humans. It is common knowledge that sugars increase palatability of food in mammals and hence its acceptance. When testing components to increase the attractiveness of food, sugars always rate high.

But in the case of pigs, however, the increase in acceptance does not mean an increase in the food intake. That is because the pig is a voracious species that eats whether the food is sweet or not, until it feels satiated. An increase in only preference and attractiveness does not correlate well with difference in total food intake. This is the reason why feed consuming trials based on simple palatability don't show great differences. This reality is exemplified by a field test, here quoting only sorbitol, lactose and glucose to make it short, where nine homogeneous pig groups were prepared, distributed in 15 pens of 12 animals each. The average weight in the animals was 60 kg. All the animals were given the same food, but the sugar contents varied in each group. The food intake was recorded in kilograms during 30 days as shown in tables A1, A2 and A3.

A1. - When the added sugar is sorbitol
Fattening pigs. Food intake (kg) versus sorbitol contents in food

| | Sorbitol contents in pig food | | | | | | | | |
|---|---|---|---|---|---|---|---|---|---|
| Pen | 0.00% | 0.10% | 0.20% | 0.30% | 0.40% | 0.50% | 0.60% | 0.75% | 1.00% |
| 1 | 868 | 875 | 855 | 859 | 879 | 880 | 854 | 853 | 877 |
| 2 | 851 | 871 | 857 | 851 | 850 | 879 | 855 | 875 | 851 |
| 3 | 878 | 868 | 871 | 861 | 853 | 880 | 866 | 879 | 860 |
| 4 | 864 | 871 | 866 | 863 | 870 | 867 | 859 | 875 | 866 |
| 5 | 866 | 862 | 874 | 872 | 856 | 860 | 880 | 878 | 867 |
| 6 | 859 | 870 | 864 | 854 | 852 | 861 | 875 | 875 | 866 |
| 7 | 865 | 868 | 867 | 852 | 856 | 865 | 860 | 855 | 853 |
| 8 | 850 | 860 | 867 | 870 | 858 | 868 | 853 | 859 | 879 |
| 9 | 879 | 852 | 866 | 866 | 870 | 859 | 880 | 867 | 852 |
| 10 | 866 | 859 | 872 | 877 | 855 | 860 | 880 | 861 | 864 |
| 11 | 853 | 851 | 860 | 875 | 865 | 880 | 855 | 858 | 866 |
| 12 | 854 | 867 | 865 | 875 | 873 | 856 | 877 | 872 | 872 |
| 13 | 851 | 863 | 850 | 868 | 878 | 861 | 869 | 860 | 876 |
| 14 | 877 | 857 | 862 | 856 | 871 | 850 | 857 | 850 | 875 |
| 15 | 858 | 868 | 860 | 854 | 855 | 857 | 858 | 851 | 856 |
| Total | 12939 | 12962 | 12956 | 12953 | 12941 | 12983 | 12978 | 12968 | 12980 |

A2. - When the added sugar is lactose
Fattening pigs. Food intake (kg) versus lactose contents in food

| | Lactose contents in pig food | | | | | | | | |
|---|---|---|---|---|---|---|---|---|---|
| Pen | 0.00% | 0.10% | 0.20% | 0.30% | 0.40% | 0.50% | 0.60% | 0.75% | 1.00% |
| 1 | 879 | 867 | 850 | 866 | 868 | 852 | 859 | 863 | 876 |
| 2 | 858 | 878 | 879 | 864 | 872 | 880 | 875 | 855 | 877 |
| 3 | 857 | 875 | 880 | 873 | 857 | 857 | 869 | 862 | 874 |
| 4 | 855 | 863 | 869 | 872 | 873 | 858 | 863 | 868 | 867 |
| 5 | 873 | 867 | 876 | 868 | 855 | 859 | 855 | 878 | 855 |
| 6 | 856 | 873 | 872 | 869 | 873 | 880 | 855 | 880 | 872 |
| 7 | 879 | 869 | 873 | 879 | 877 | 854 | 867 | 865 | 878 |
| 8 | 873 | 872 | 868 | 862 | 868 | 859 | 860 | 852 | 867 |
| 9 | 850 | 873 | 876 | 868 | 874 | 868 | 867 | 851 | 865 |
| 10 | 855 | 858 | 866 | 875 | 855 | 859 | 860 | 858 | 878 |
| 11 | 872 | 864 | 875 | 879 | 859 | 856 | 875 | 850 | 880 |
| 12 | 860 | 853 | 873 | 868 | 867 | 874 | 877 | 866 | 868 |
| 13 | 880 | 860 | 866 | 858 | 862 | 874 | 856 | 862 | 878 |
| 14 | 875 | 876 | 868 | 854 | 876 | 873 | 873 | 865 | 856 |
| 15 | 870 | 855 | 852 | 861 | 857 | 878 | 854 | 863 | 867 |
| Total | 12992 | 13003 | 13043 | 13016 | 12993 | 12981 | 12965 | 12938 | 13058 |

A3. - When the added sugar is glucose
Fattening pigs. Food intake (kg) versus glucose contents in food

| | Glucose contents in pig food | | | | | | | | |
|---|---|---|---|---|---|---|---|---|---|
| Pen | 0.00% | 0.10% | 0.20% | 0.30% | 0.40% | 0.50% | 0.60% | 0.75% | 1.00% |
| 1 | 876 | 879 | 884 | 910 | 919 | 926 | 880 | 840 | 812 |
| 2 | 856 | 854 | 894 | 903 | 912 | 924 | 878 | 831 | 810 |
| 3 | 850 | 856 | 886 | 907 | 902 | 914 | 882 | 835 | 813 |
| 4 | 876 | 868 | 897 | 896 | 917 | 914 | 881 | 832 | 823 |
| 5 | 856 | 853 | 896 | 910 | 908 | 908 | 876 | 824 | 822 |
| 6 | 868 | 871 | 881 | 905 | 917 | 907 | 888 | 834 | 815 |
| 7 | 877 | 862 | 893 | 904 | 905 | 905 | 876 | 821 | 804 |
| 8 | 865 | 851 | 885 | 908 | 918 | 920 | 881 | 832 | 822 |
| 9 | 852 | 876 | 881 | 907 | 906 | 906 | 886 | 820 | 825 |
| 10 | 855 | 874 | 894 | 893 | 914 | 922 | 890 | 821 | 811 |
| 11 | 872 | 859 | 894 | 900 | 908 | 921 | 879 | 820 | 814 |
| 12 | 862 | 857 | 884 | 904 | 918 | 916 | 880 | 840 | 825 |
| 13 | 852 | 879 | 892 | 900 | 907 | 904 | 893 | 835 | 823 |
| 14 | 869 | 875 | 900 | 894 | 901 | 905 | 885 | 828 | 813 |
| 15 | 870 | 865 | 886 | 890 | 917 | 919 | 881 | 837 | 811 |
| Total | 12956 | 12979 | 13347 | 13531 | 13669 | 13711 | 13236 | 12450 | 12243 |

Surprisingly and unexpectedly, there is no significant increase in the pig's feeding habits in the presence of these sugars, no matter the sugar concentration. These results are also obtained with the rest of sugars but xylitol.

In food intake trials, in which pigs have two or more choices of different feed, pigs clearly eat more feed added with xylitol, than plain feed or feed added with any other sweetener.

| | | | Food | | Food | | Food |
|---|---|---|---|---|---|---|---|
| | | | contain- | | contain- | | contain- |
| | | | ing | | ing | | ing |
| | Plain | | 0.25% | | 0.25% | | 0.25% |
| | food | | Sorbitol | | Sucrose | | Xylitol |
| | (Month- | | (Month- | | (Month- | | (Month |
| | ly | | ly | | ly | | -ly |
| | intake | | intake | | intake | | intake |
| Pen | kg) | Pen | kg) | Pen | kg) | Pen | kg) |
| 1 | 866 | 16 | 858 | 31 | 868 | 46 | 995 |
| 2 | 865 | 17 | 864 | 32 | 872 | 47 | 979 |
| 3 | 869 | 18 | 867 | 33 | 864 | 48 | 988 |
| 4 | 861 | 19 | 862 | 34 | 873 | 49 | 991 |
| 5 | 863 | 20 | 866 | 35 | 874 | 50 | 987 |
| 6 | 870 | 21 | 859 | 36 | 868 | 51 | 983 |
| 7 | 867 | 22 | 860 | 37 | 869 | 52 | 990 |
| 8 | 859 | 23 | 863 | 38 | 861 | 53 | 988 |
| 9 | 858 | 24 | 868 | 39 | 872 | 54 | 980 |
| 10 | 864 | 25 | 864 | 40 | 873 | 55 | 984 |
| 11 | 863 | 26 | 865 | 41 | 879 | 56 | 986 |
| 12 | 867 | 27 | 866 | 42 | 875 | 57 | 991 |
| 13 | 865 | 28 | 861 | 43 | 874 | 58 | 982 |
| 14 | 868 | 29 | 864 | 44 | 869 | 59 | 987 |
| 15 | 864 | 30 | 869 | 45 | 870 | 60 | 983 |
| Total | 12969 | | 12956 | | 13061 | | 14813 |

This xylitol effect is especially noticeable with weaning pigs, where the usual focusing of having pigs eating more has to be substituted for the really important consequence: greater body weight growth.

In a field test conducted on a mix of 400 male and female weaning pigs, in the age of 21 days, distributed in 8 pens with 50 animals each, where the weaning pigs in pens 1 to 4 were fed with plain water and pre-starter food and, where the weaning pigs in pens 5 to 8 were fed with water and pre-starter food containing both 0.35% xylitol, the results when the animals reached the age of 42 days were that:
the joint pigs in pens 1 to 4 showed a total body weight increase of 755.5 kg.
the joint pigs in pens 5 to 8 showed a total body weight increase of 843.0 kg.

That is, after three weeks feeding, the weaning pigs fed with pre-starter food containing 0.35% xylitol and attained a total body weight increase that was 13.4% greater than the body weight increase achieved in weaning pigs fed in the same conditions but without xylitol.

Weaning pigs fed with plain water and pre-starter food.

| | | | | Body |
|---|---|---|---|---|
| | Initial total | Final total | Body weight | weight |
| Pen | body weight | body weight | increase | increase % |
| 1 | 271.0 | 465.5 | 194.5 | |
| 2 | 256.0 | 438.0 | 182.0 | |
| 3 | 268.5 | 460.5 | 192.0 | |
| 4 | 263.0 | 450.0 | 187.0 | |
| Total | 1,058.5 | 1,814.0 | 755.5 | 71.4 |

Weaning pigs fed with water and pre-starter food containing 0.35% xylitol.

| | | | | Body |
|---|---|---|---|---|
| | Initial total | Final total | Body weight | weight |
| Pen | body weight | body weight | increase | increase % |
| 5 | 266.5 | 474.0 | 207.5 | |
| 6 | 254.0 | 465.0 | 211.0 | |
| 7 | 259.5 | 469.0 | 209.5 | |
| 8 | 260.5 | 475.5 | 215.0 | |
| Total | 1,040.5 | 1,883.5 | 843.0 | 81.0 |

The body weight increase in weaning pigs fed with food containing other sugars than xylitol was not substantively different from the body weight increase in the case of similar weaning pigs fed with plain food. The reason is that the food palatability increase produced by the ‘simple’ sugars does not exert any effect on the weaning pig's food intake because whether the feed is sweetened or is not, the weaning pig shall eat until it feels full and satiety stops it.

Then, being the factor to condition the food intake the time span during which the satiety feeling prevails, the sweetening effect of sugars alone shall not lead to any remarkable change in the voracious food intake in the pig.

Now, the satiety feeling is produced, at least in mammals, by the pressure that the ingested food exerts on the stomach's wall, and xylitol is a wetting agent. The wetting agents have the property of changing the surface tension of water and will change deeply the physiological characteristics of the stomach's content. Water and gastric juices penetrate better in the solid food particles, which consequently are dispensed in a shorter time to the intestines, that is, emptying the stomach in a shorter time and so reducing the food pressure on the stomach wall and hence eliminating the satiety feeling. As another benefit and unexpected result, with xylitol as additive in the food the satiety feeling in weaning pigs exists during shorter time than if no wetting effect was present in the stomach and, given the mentioned voracious nature of this species, longer time spans without satiety feeling shall lead to longer time periods eating. That is, the use of xylitol leads to an increase in the food intake that will produce the desired higher rate of body weight increase in the weaning pigs.

On the other hand, xylitol enjoys an extremely sweetness potency in pigs, as it was established by Glaser et al. in their work “Gustatory responses of pigs to various natural and artificial compounds known to be sweet in man” published in Food Chemistry 68 (2000) 375-385, where they summarize their results in the following table:

Comparison (on a molar basis relative to sucrose) between the
sweetness potencies in humans and the preferences in pigs for
various polyhydroxy compounds (carbohydrates and polyols)

| | Potencies | Preferences |
|---|---|---|
| Carbohydrates and polyols | in humans^{a} | in pigs^{b} |
| Xylitol | 0.30 | 1.00 |
| Melezitose | 0.35 | 0.25 |
| Lactose | 0.33 | 0.146 |
| D-Glucose | 0.33 | 0.146 |
| L-Glucose | 0.25 | 0.125 |
| D-Mannose | 0.25 | 0.125 |
| Melibiose | 0.25 | 0.125 |
| Trehalose | 0.25 | 0.125 |
| Raffinose | 0.25 | 0.125 |
| Methyl β-D-glucopyrunoside | 0.25 | 0.125 |
| DL-Threitol | 0.25 | 0.125 |
| Erythritol | 0.25 | 0.062 |
| D-Arabitol | 0.25 | 0.062 |
| Ribitol | 0.25 | 0.062 |
| Mannitol | 0.25 | 0.062 |
| Sorbitol | 0.25 | 0.25 |
| n-Galactose | 0.20 | 0.125 |
| D-Xylose | 0.20 | 0.125 |
| n-Ribose | 0.15 | 0.062 |

^{a}The approximate sweetness potencies in humans (on a molar basis relative to a 2% sucrose solution) were evaluated (or re-evaluated) by six trained panelists of our laboratory through the paired-comparison (two-sample) test (see Amerine, Pangbora & Roessler, 1965b).
^{b}The approximate relative preferences in pigs were estimated from the lowest concentration of sucrose able to induce a preference in all the animals of the same experimental group (14.60 mmol/l) divided by the lowest concentration of the tested compound which is able to induce a preference in all the animals of the same group (e.g. 29.14 mmol/l for n-fructose).

Here we can see the surprising results from the comparison between the sweetness potencies in humans and pigs for various sugar alcohols shows a repetitive pattern where the sugar's sweetness potency in pigs is four to eight times lower than in humans, but with two remarkable exceptions: sorbitol, with same potency in both species (sorbitol is not considered ‘sweet’ by humans), and xylitol, which is unexpectedly three times more palatable in pigs than in humans or else four to eight times more palatable than any other sugar alcohol in pigs.

As a consequence, xylitol is the only compound that meets both necessary criteria to produce, as additive, a greater body weight increase in weaning pigs during their feeding period: reduces satiety and makes food attractive (palatable). No other known sugar alcohol or sweetener combined or alone results in the two highly desirable features.

Adequate veterinary inspection of the animals involved with the xylitol-containing food showed that the animals were extensively healthy. Besides promoting healthy and faster increase in the weaning pig's body weight, xylitol combines also the following two zootechnical convenient characteristics:
Harmless to humans consuming meat from pigs fed with xylitol-containing food; and
Innocuous to the environment.

Xylitol's combined features result in a valuable economic effect to be exploited in the intensive pig farming.

Xylitol contents in the range 0.01 to 4% in weight with respect to the food improve the rate in the body weight growth of weaning pigs as they reduce the time of permanence of the food in the stomach helping the weaning pig to resume its voracious activities.

### EXAMPLE 1

3.5 kilograms of xylitol are added to the ingredients of one metric ton of pre-starter food as it is prepared in the factory. The ready mixture can be served to weaning pigs.

### EXAMPLE 2

3.5 kilograms of xylitol are dissolved in 1000 liters of drinking water aimed to the weaning pigs.

The examples must not be considered by being as limiting on the use of the applications of same.

What is claimed is:

1. A method of improving the body weight growth of weaning pigs comprising the step of providing a concentration of xylitol in the range of between 0.01 and 4% by weight in weaning pigs' food.

2. A method of improving the body weight growth of weaning pigs comprising the step of providing a concentration of xylitol in the range of between 0.01 and 4% by volume in weaning pigs' water.

3. A method of improving the body weight growth of weaning pigs according to claim 1 comprising the additional step of adding an excipient to the xylitol prior to providing said concentration of xylitol to the weaning pigs' food.

4. A method of improving the body weight growth of weaning pigs according to claim 2 comprising the additional step of adding an excipient to the xylitol prior to providing said concentration of xylitol to the weaning pigs' water.

5. A method of improving the body weight growth of weaning pigs according to claim 3 wherein said excipient is selected from the group consisting essentially of solvents, preservatives, anti-oxidants, light protectors, colorings, reabsorption booster products, disintegration boosting agents, agglutinants, lubricants and stabilisers.

6. A method of improving the body weight growth of weaning pigs according to claim 4 wherein said excipient is selected from the group consisting essentially of solvents, preservatives, anti-oxidants, light protectors, colorings, reabsorption booster products, disintegration boosting agents, agglutinants, lubricants and stabilisers.

7. A method of improving the body weight growth of weaning pigs according to claim 1 comprising the additional step of adding a synergising product to the weaning pigs' food.

8. A method of improving the body weight growth of weaning pigs according to claim 2 comprising the additional step of adding a synergising product to the weaning pigs' water.

9. A method of improving the body weight growth of weaning pigs according to claim 7 wherein said synergising product is selected from the group consisting essentially of acesulfame, alitame, aspartame, superaspartame, dulcin, monellin, neohesperidine dihydrochalcone, 5-nitro-2-propoxianilline, saccharine, sucralose, thaumatine, amino-acids such as arginine, glycine and tryptophan.

10. A method of improving the body weight growth of weaning pigs according to claim 8 wherein said synergising product is selected from the group consisting essentially of acesulfame, alitame, aspartame, superaspartame, dulcin, monellin, neohesperidine dihydrochalcone, 5-nitro-2-propoxianilline, saccharine, sucralose, thaumatine, amino-acids such as arginine, glycine and tryptophan.
